(19) United States
(12) Patent Application Publication
(10) Pub. No.: US 2004/0010723 A1
(43) Pub. Date: Jan. 15, 2004

(54) Network security method

(76) Inventor: Ping Zhang, Tianjin (CN)

Correspondence Address: Fortune Law Group, Suite 315, 100 Century Center Court, San Jose, CA, 95112, US

(21) Appl. No.: 10/404,709

(22) Filed: Mar. 31, 2003

(30) Foreign Application Priority Data
Apr. 3, 2002 (CN) 02116528.9

(51) Int. Cl. H04L 9/32

(52) U.S. Cl. 713/202

(57) ABSTRACT

A method of ensuring network security includes the steps of (1) accepting a user's input of a first information in an internet server, (2) transferring the user's first information from the internet server to a security server, (3) accepting a user's input of a second information from a specific telecommunications terminal in a telecommunications server, (4) verifying the user's use of the specific telecommunications terminal against the user's first information in the telecommunications server, (5) transferring the user's second information to the security server, and (6) transferring the user's first information and second information to an authentication server.

### BACKGROUND OF THE INVENTION

This invention relates to network security and more particularly to a network security method wherein information used to authenticate a network transaction is entered in two separate domains.

The development of network information technology and the expansion of e-commerce have had a great impact on the traditional concept and methodology of running enterprises. Internet e-commerce based on internet technology has brought great changes to enterprise activities and has provided real convenience to numerous users.

However, with the disorder of the internet and the high frequency of hacker attacks, people's greatest psychological barrier is “Is the internet secure? Should I use my account password on the net without worries?”

Network security may be expressed as (1) prevention of information to be stolen or falsified during transactions and (2) mutual identification of the two parties to a transaction; account or password may be stolen by other parties.

Currently the most widely used network security is SSL data encryption protocol. After a user logs in and identifies himself/herself, all data communicated between the user and server is encrypted with an encryption key, until the user logs out. The encryption effectiveness directly depends on the length of the encryption key which is usually 40-128 bits. The longer the key, the higher the complexity of processing.

Currently there are two ways of identification and CA authentication. The traditional way of identification uses username and password to identify a user. But since a user's password can be easily intercepted during login, the user's identify may be compromised. As a result, the identification system is defeated.

A more advanced identification system, such as that used by online banks, applies multiple authentications of “RSA public key cryptography” based encryption, digital signature mechanism and user login passwords. The server verifies the user's digital signature and password, and identifies the user only after all checks have passed.

In addition, the user's security consciousness is another important factor in network security. Nowadays, users lack security consciousness. They do not pay attention to protecting their passwords, or they set their passwords to their birthdays or other easily guessed numbers.

The three problems mentioned above are the major problems threatening network security at the present time. They are the major obstacles of the development of e-commerce.

The currently prevailing SSL encryption protocol and the “RSA public key” encryption scheme are susceptible to compromise, because all encrypted information is exchanged within one domain.

As can be seen, there is a need for a network security system and method that overcomes the limitations of the prior art.

### SUMMARY OF THE INVENTION

In accordance with the present invention, a method of ensuring network security includes the steps of (1) accepting a user's input of a first information in an internet server, (2) transferring the user's first information from the internet server to a security server, (3) accepting a user's input of a second information from a specific telecommunications terminal in a telecommunications server, (4) verifying the user's use of the specific telecommunications terminal against the user's first information in the telecommunications server, (5) transferring the user's second information to the security server, and (6) transferring the user's first information and second information to an authentication server.

In accordance with an alternate embodiment of the present invention, a method of ensuring network security comprising the steps of (1) accepting a user's input of a first information in an e-commerce network comprising an internet server coupled to a security server, (2) accepting a user's input of a second information from a specific telecommunications terminal in a telecommunications server, (3) verifying the user's use of the specific telecommunications terminal against the user's first information in the telecommunications server, (4) transferring the user's second information to the e-commerce network, and (5) transferring the user's first information and second information to an authentication server by means of a leased line.

In accordance with another embodiment of the present invention, a method of ensuring network security comprising the steps of (1) accepting a user's input of a first information in one of a plurality of e-commerce servers, (2) transferring the user's first information from the one of a plurality of e-commerce servers to a security server by means of a leased line, (3) accepting a user's input of a second information from a specific telecommunications terminal in a telecommunications server, (4) verifying the user's use of the specific telecommunications terminal against the user's first information in the telecommunications server, (5) transferring the user's second information to the security server, and (6) transferring the user's first information and second information to an authentication server by means of a leased line.

In accordance with yet another embodiment of the present invention, a method of ensuring network security comprising the steps of (1) accepting a user's input of a first information in one of a plurality of e-commerce servers, (2) transferring the user's first information from the one of a plurality of e-commerce servers to a bank local network by means of a leased line, the bank local network including a security server coupled to a bank server by means of a leased line, the bank server coupled to an authentication server and a transaction server, (3) accepting a user's input of a second information from a specific telecommunications terminal in a telecommunications server, (4) verifying the user's use of the specific telecommunications terminal against the user's first information in the telecommunications server, and (5) transferring the user's second information to the bank local network.

These and other features, aspects and advantages of the present invention will become better understood with reference to the following drawings, description and claims.

### BRIEF DESCRIPTION OF THE DRAWINGS

FIG. 1 is a schematic representation of a network security system in accordance with an embodiment of the invention;

FIG. 2 is a schematic representation of a network security system in accordance with another embodiment of the invention;

FIG. 3 is a schematic representation of a network security system in accordance with another embodiment of the invention;

FIG. 4 is a schematic representation of a network security system in accordance with yet another embodiment of the invention;

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

The method of the present invention goes beyond the limit of encryption within a single domain. It regards the internet as a virtual domain. The virtual domain has the feature that it has no time-space, and the server cannot know whether the person sitting in front of a computer is the real owner or not. On the other hand, it regards the telecommunication network (such as GSM network, CDM network, PSTN network) as another domain—the reality domain. This domain has the feature that there is a time-space, the exchange system knows the telephone caller is the real owner. In this domain, the owner is required to have a voice/data terminal with his/her own specified number, and to have the number stored in a corresponding authentication server.

The security mechanism of this invention is mainly based on the following three principles. (1) The most secured systems are those that the protected party does not appear in the environment the attacker lives. (2) Any person, including the owner, is not trusted. The owner is only authorized when he or she uses the terminal with the specified number. This terminal is not easily accessed by other parties. (3) If the protected party has to appear in an insecure environment, he or she should appear for only a short period of time.

Based on the above three principles, this invention constitutes a new security mechanism. Unlike traditional mechanisms, this mechanism adds a security server connecting the internet and telecommunication domain. The server is responsible for the collection, aggregation and transmission of information coming from the two domains. The basic information and requests of the users are entered into the internet domain, at the same time a specified input terminal number for the telecommunication domain is also entered. A server transmits this set of information to the security server connecting the internet domain and telecommunication domain. The security server waits for information such as password to be entered from the specific terminal. The aggregation of information entered from the two different domains comprises the complete user information to be used for identification recognition by the transaction server, once the user information is transmitted to the corresponding server, the password information just entered is deleted immediately from the security server. If after the information from the internet domain reaches the telecommunication domain, the user does not enter information such as password from the specified terminal within a certain time frame (for example, 5 minutes), the transaction is cancelled.

Meanwhile, the server in the. telecommunication domain relies on the recognition of the caller number from the telecommunication switch to identify the owner, instead of the information entered into the terminal, thus guarantees that other parties cannot use the owner's own terminal to enter password and prevents attacks.

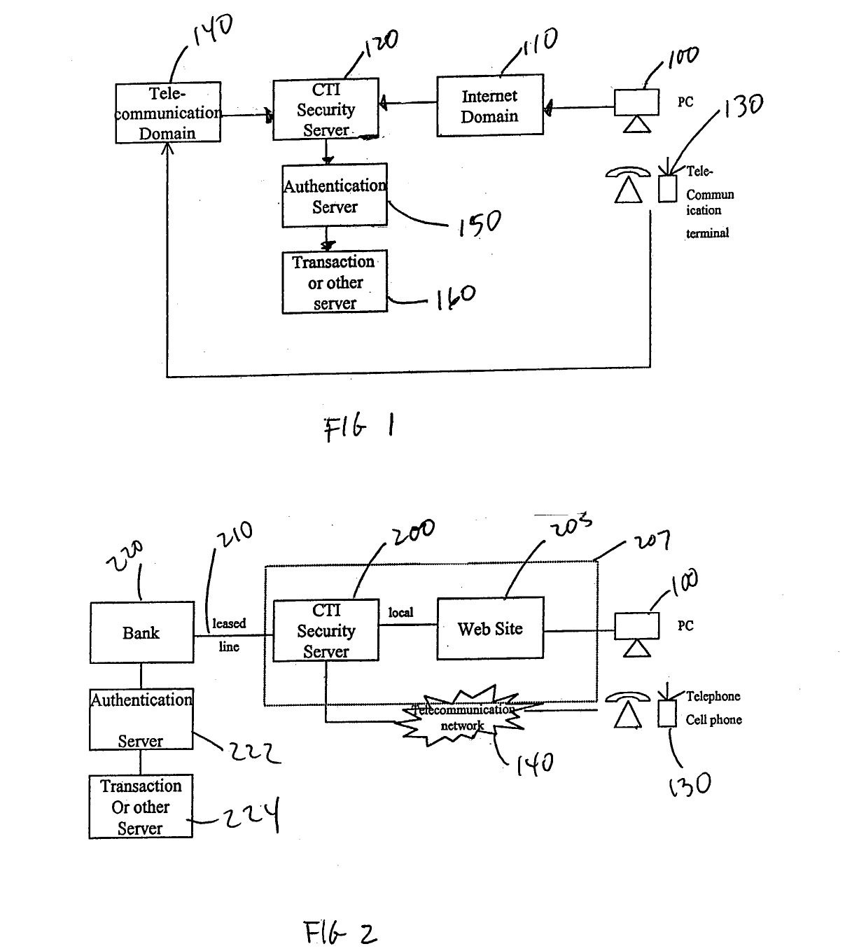

With reference to FIG. 1, a method of the invention will be described. In a first step, a user inputs a first information including basic account information but excluding a password through a PC 100 or other network terminal. In a second step, an internet server 110 transfers the user input, including a user specified telecommunication terminal number, to a security server 120. In a third step, the user inputs a second information including the password or other identifying information from the specified telecommunication terminal 130 within a certain timeframe. In a fourth step, a telecommunication domain server 140 receives the information from the specified telecommunication terminal 130 and verifies the telecommunication terminal number. In a fifth step, the security server 120 sends the information from the two domain servers 110 and 140 to an authentication server 150. In a sixth step, a transaction is commenced in a transaction server 160.

Advantageously, the method of the invention includes entry of the account number and password in two different domains. Even if others know such information, they are not able to attack through the network or conduct other activities. Furthermore, the system is low-cost, reliable, simple and easy to use. The effectiveness of security is not limited by the length of the encryption key. Finally, the method eliminates people's fear of lack of network security.

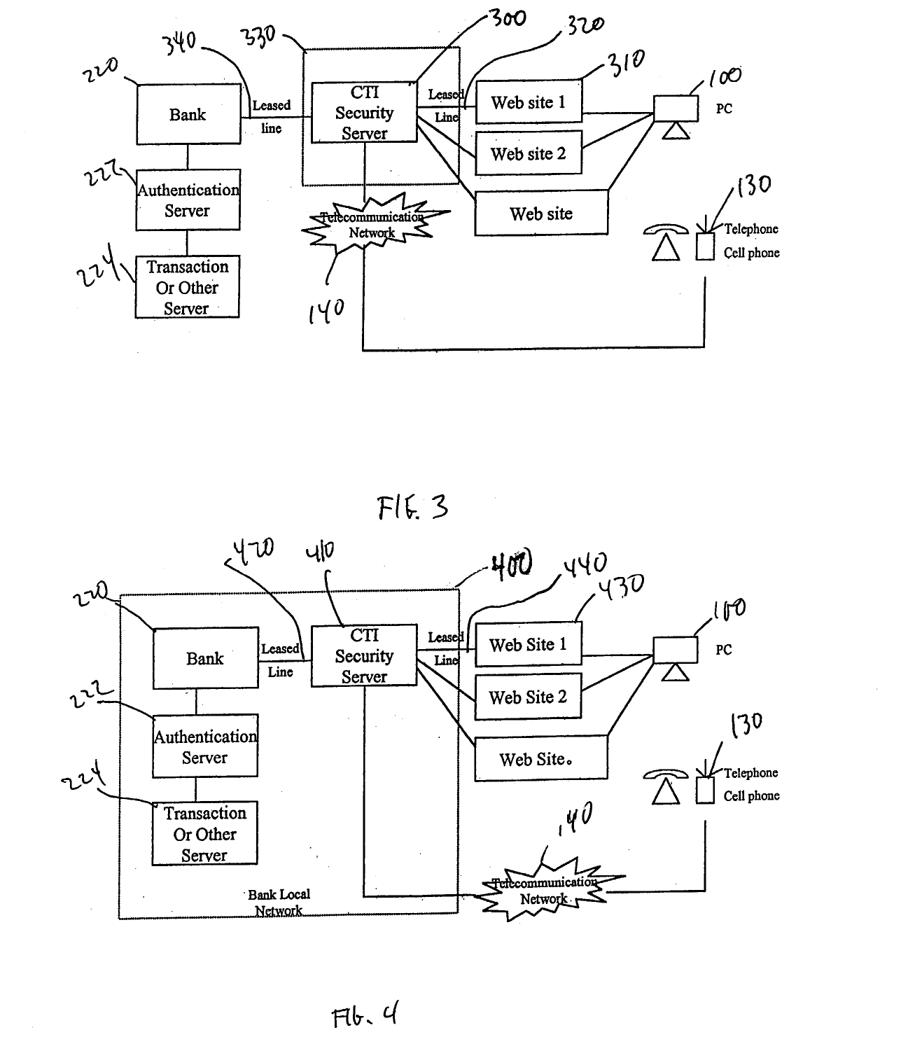

The method of the invention has three typical applications. (1) Use a security server connecting the two domains in an e-commerce network, meanwhile use leased lines to transmit user information to transaction banks as shown in FIG. 2. (2) Authority organizations set up dedicated authentication center, various e-commerce web sites use encrypted leased lines to connect to such authentication center. The authentication center connects to users through telecommunication network as shown in FIG. 3. (3) Banks set up dedicated authentication centers and security servers to be used by e-commerce web sites as shown in FIG. 4.

With reference to FIG. 2, there is shown a network topology in accordance with the invention including a security server 200 associated with an e-commerce server 205 in an e-commerce network 207. The e-commerce network 207 connects the two domains as previously described with the e-commerce server 205 serving as the internet domain server 110. Leased lines 210 may connect the e-commerce network 207 with a bank server 220 having an authentication server 222 and a transaction server 224.

With reference to FIG. 3, there is shown another network topology in accordance with the invention including a security server 300 which may be connected to a plurality of e-commerce servers 310 by means of leased lines 320. Security server 300 may serve as an authentication center 330 for the plurality of e-commerce servers 310. The authentication center 330 may be connected to the bank server 220 by leased line 340. Bank server 220 may be connected to authentication server 222 and to transaction server 224.

With reference to FIG. 4, there is shown yet another network topology in accordance with the invention including a bank local network 400. Bank local network 400 may include a security server 410 connected to the bank server 220 by means of a leased line 420. Bank server 220 may be connected to authentication server 222 and to transaction server 224. A plurality of websites 430 may be connected to the bank network 400 by means of leased lines 440.

In contrast to the methods of the prior art, the present invention fundamentally solves the problem of insecurity caused by information interception and falsification during network transmission. Further, it fundamentally resolves identification of two parties in a transaction, preventing abuse of accounts by other parties. Finally, it fundamentally solves loss by leaking of account/password caused by users' lack of security awareness. The method of the invention can be widely used in various network security and e-commerce fields.

As shown, the method of the invention overcomes the deficiencies of the prior art by providing a network security method wherein information used to authenticate a network transaction is entered in two separate domains. It should be understood, of course, that the foregoing relates to preferred embodiments of the invention and that modifications may be made without departing from the spirit and scope of the invention. Any such modifications should in no way limit the scope of the invention, which should only be determined based on the following claims.

I claim:

1. A method of ensuring network security comprising the steps of:
(1) accepting a user's input of a first information in an internet server;
(2) transferring the user's first information from the internet server to a security server;
(3) accepting a user's input of a second information from a specific telecommunications terminal in a telecommunications server;
(4) verifying the user's use of the specific telecommunications terminal against the user's first information in the telecommunications server;
(5) transferring the user's second information to the security server; and
(6) transferring the user's first information and second information to an authentication server.

2. The method of claim 1, wherein the first information further comprises a user specified telecommunication terminal number identifying the specific telecommunications terminal.

3. The method of claim 1, wherein the first information does not include a password.

4. The method of claim 1, wherein the first information further comprises account information.

5. The method of claim 1, wherein the second information further comprises a password.

6. The method of claim 1, further comprising the step of authenticating the user's first and second information in the authentication server.

7. The method of claim 6, further comprising the step of initiating a transaction in a transaction server upon authenticating the user's first and second information in the authentication server.

8. A method of ensuring network security comprising the steps of:
(1) accepting a user's input of a first information in an e-commerce network comprising an internet server coupled to a security server;
(2) accepting a user's input of a second information from a specific telecommunications terminal in a telecommunications server;
(3) verifying the user's use of the specific telecommunications terminal against the user's first information in the telecommunications server;
(4) transferring the user's second information to the e-commerce network; and
(5) transferring the user's first information and second information to an authentication server by means of a leased line.

9. The method of claim 8, wherein the first information further comprises a user specified telecommunication terminal number identifying the specific telecommunications terminal.

10. The method of claim 8, wherein the first information does not include a password.

11. The method of claim 8, wherein the first information further comprises account information.

12. The method of claim 8, wherein the second information further comprises a password.

13. The method of claim 8, further comprising the step of authenticating the user's first and second information in the authentication server.

14. The method of claim 13, further comprising the step of initiating a transaction in a transaction server upon authenticating the user's first and second information in the authentication server.

15. A method of ensuring network security comprising the steps of:
(1) accepting a user's input of a first information in one of a plurality of e-commerce servers;
(2) transferring the user's first information from the one of a plurality of e-commerce servers to a security server by means of a leased line;
(3) accepting a user's input of a second information from a specific telecommunications terminal in a telecommunications server;
(4) verifying the user's use of the specific telecommunications terminal against the user's first information in the telecommunications server;
(5) transferring the user's second information to the security server; and
(6) transferring the user's first information and second information to an authentication server by means of a leased line.

16. The method of claim 15, wherein the first information further comprises a user specified telecommunication terminal number identifying the specific telecommunications terminal.

17. The method of claim 15, wherein the first information does not include a password.

18. The method of claim 15, wherein the first information further comprises account information.

19. The method of claim 15, wherein the second information further comprises a password.

20. The method of claim 15, further comprising the step of authenticating the user's first and second information in the authentication server.

21. The method of claim 20, further comprising the step of initiating a transaction in a transaction server upon authenticating the user's first and second information in the authentication server.

22. A method of ensuring network security comprising the steps of:
(1) accepting a user's input of a first information in one of a plurality of e-commerce servers;
(2) transferring the user's first information from the one of a plurality of e-commerce servers to a bank local network by means of a leased line, the bank local network including a security server coupled to a bank server by means of a leased line, the bank server coupled to an authentication server and a transaction server;
(3) accepting a user's input of a second information from a specific telecommunications terminal in a telecommunications server;
(4) verifying the user's use of the specific telecommunications terminal against the user's first information in the telecommunications server; and
(5) transferring the user's second information to the bank local network.

23. The method of claim 22, wherein the first information further comprises a user specified telecommunication terminal number identifying the specific telecommunications terminal.

24. The method of claim 22, wherein the first information does not include a password.

25. The method of claim 22, wherein the first information further comprises account information.

26. The method of claim 22, wherein the second information further comprises a password.

27. The method of claim 22, further comprising the step of authenticating the user's first and second information in the authentication server.

28. The method of claim 27, further comprising the step of initiating a transaction in a transaction server upon authenticating the user's first and second information in the authentication server.
